(19) United States
(12) Patent Application Publication
(10) Pub. No.: US 2003/0230851 A1
(43) Pub. Date: Dec. 18, 2003

(54) Metal bellows mechanical seal

(76) Inventors: Alan James Roddis, Sheffield (GB); Christopher Newton, Rotherham (GB)

Correspondence Address: MYERS BIGEL SIBLEY & SAJOVEC, PO BOX 37428, RALEIGH, NC, 27627, US

(21) Appl. No.: 10/391,469

(22) Filed: Mar. 18, 2003

(30) Foreign Application Priority Data
Mar. 18, 2002 (GB) GB 0206345.1

(51) Int. Cl. F16J 15/34

(52) U.S. Cl. 277/391; 277/306

(57) ABSTRACT

A mechanical seal comprises a drive end, a seal face holder with a seal face inserted into the seal face holder. A metal bellows stack is located between the drive end and the seal face holder, and a drive sleeve is secured to the drive end. The drive sleeve is a separate component to the drive end and the drive sleeve is located radially inwardly of the metal bellows stack.

### RELATED APPLICATION

This application claims priority to Great Britain Patent Application No. GB 0206345.1, filed Mar. 18, 2002, the disclosure of which is hereby incorporated herein by reference.

### FIELD OF THE INVENTION

This invention relates to mechanical seals, in particular mechanical seals containing one or more metal bellows seal faces.

### BACKGROUND OF THE INVENTION

A mechanical seal comprises a “floating” component which is mounted axially movably around the rotary shaft of, for example a pump, and a “static” component which is axially fixed, typically being secured to a housing. The floating component has a flat annular end face, i.e. its seal face, directed towards a complementary seal face of the static component. The floating component is urged towards the static component to close the seal faces together to form a sliding face seal, usually by means of one or more springs. Alternatively, instead of one or more springs, a metal bellows unit may be employed as the floating component.

In use, one of the floating and static components rotates; this component is therefore referred to as the rotary component. The other of the floating and static components does not rotate and is referred to as the stationary component.

Those seals, whose floating component is rotary, are described as rotary seals. If the floating component is stationary, the seal is referred to as a stationary seal.

If the sliding seal between the rotary and stationary components are assembled and pre-set prior to despatch from the mechanical seal manufacturing premises, the industry terminology for this is “cartridge seal”. If the rotary and stationary components are despatched individually (unassembled) from the mechanical seal manufacturing premises, the industry terminology for this is “component seal”.

Metal bellows assemblies are frequently employed in mechanical seal design, as they facilitate the axial movement of a floating mechanical seal face without the need for an axially floating elastomer.

The removal of the floating elastomer offers certain advantages in thermal and/or chemical applications since the elastomer is less susceptible to premature failure.

Further advantages are gained if the metal bellows unit is supplied as a cartridge seal assembly as it is widely accepted that cartridge seals offer user installation benefits.

Cartridge seal assemblies generally contain a single member that axially positions the respective components that make up the seal assembly. This member is typically referred to as a cartridge sleeve. The cartridge sleeve is conventionally radially disposed to the mechanical seal faces and extends axially beyond the mechanical seal faces.

A metal bellows unit is conventionally attached to the cartridge sleeve in one of two methods. The metal bellows is either attached in a permanent or non-permanent method.

In the non-permanent method, the metal bellows is a separate component attached to the cartridge sleeve by a mechanical means. A typical mechanical means is by use of one or more screws. This allows the metal bellows to be removed and replaced without damage to other components, in particular the cartridge sleeve. Reference is made to our co-pending patent application, PCT/GB00/04122.

The disadvantage of the non-permanent fixing method is that many other components are required to fix together the two separate members. This adds to the cost of supplying the product. Furthermore, additional manufacturing complexity is placed into the respective separate members. Said members typically have to accommodate the non-permanent design by incorporating screw threads in their design. This increases the manufacturing cost of said members, further adding to the cost of supplying the product.

The alternate method of attaching metal bellows to a cartridge sleeve is by permanently fixing the metal bellows unit to the cartridge sleeve. Welding is conventionally employed as the permanent fixing method.

The main disadvantage of the permanent attachment approach is the problem over controlling seal face flatness to the very fine tolerance needed.

All mechanical seals rely on two seal faces, which are extremely flat to each other. Seal face flatness is measured in Helium light bands. It is generally accepted that a mechanical seal face should be flat to within two helium light bands. Since there are 85 helium light bands to one thousandth of an inch (0.001″) or 0.0254 mm, a seal face must be flat to 0.000022″ (0.0006 mm).

Any distortion or deviation from this flatness can cause the mechanical seal to leak and be unfit for its intended duty.

A design which allows a metal bellows to be permanently secured to a secondary member which is radially disposed and extends axially beyond the mechanical seal face, while allowing the seal face to remain perfectly flat, before and after the fixing operation, is deemed to be particularly advantageous.

It is deemed to be further advantageous if the permanent attachment of the two components is made so that said attachment is not in contact with the fluid being sealed. This suggests that the permanent attachment does not therefore need to be fluid pressure tight thereby reducing the cost of component attachment.

### BRIEF DESCRIPTION OF THE DRAWINGS

A prior art design which illustrates a design where a metal bellows unit is permanently secured to(a cartridge sleeve is shown in FIG. 1a.

The present invention is described by way of example only with reference to the accompanying drawings, in which:

FIG. 2 is a longitudinal cross section through a double bellows mechanical seal of the invention.

FIG. 3 corresponds to FIG. 2 and is a partial longitudinal cross section through a double rotary mechanical seal of the invention.

FIG. 4 corresponds to FIG. 3 and is a partial longitudinal cross section through the external rotary seal face assembly of the invention.

FIG. 5 is a longitudinal cross section through an alternate double bellows mechanical seal of the invention.

FIG. 6 corresponds to FIG. 3 and is a partial longitudinal cross section through the invention, showing by way of example only, a flow inducing mechanism on the drive end of the invention.

### DETAILED DESCRIPTION OF PREFERRED EMBODIMENTS

It is considered self evident to the experienced reader that the invention may be employed for both rotary seals and stationary seals, and/or, for single mechanical seals and triple mechanical seals as well as double mechanical seals, whether designed in a cartridge or component seal format.

It is also considered self evident that the invention may be used with metallic components as well as non-metallic components.

From FIG. 1a. An experienced reader will note that the bellows unit (10) is permanently secured to the corresponding cartridge sleeve (11) by a radially outwardly positioned circumferential weld (12).

From FIG. 1b, it will be noted that two parts are created prior to their permanent fixing together. Said parts, the bellows assembly (10) and the cartridge sleeve (11) are typically joined at the circumferential weld positions (7) and (8). Prior to securing the two parts, the bellows assembly (10), in particular the seal face insert (16) will be lapped and flatness checked. The seal face insert (16) must generally be flat to within two helium light bands at sealing surface (9).

Referring to FIG. 1c. In order to create the circumferential weld (12) the bellows unit (10) must be axially compressed while split weld rings (13) are positioned between each metal bellows pair of convolutions (14).

The split weld rings (13) can be thought of as spacer rings which not only separate the bellows convolutions (14) from each other, but take away some of the heat generated in the welding process.

The axial compression, denoted as “Z”, of the metal bellows convolutions (14) with weld rings (13) in place, is extremely important in order for a quality leak proof weld to be produced.

In the process of axially compressing (Z) the metal bellows unit (10), certain radial and axial loads are placed on the seal face holder (15). As the seal face holder (15) is a shrink fit to the seal face insert (16), all radial and/or axial loads are transmitted into the seal face insert (16). Said loads change the seal face flatness (17) and therefore effect the sealing performance of the assembly.

It will be noted that since the cartridge sleeve (11) is radially displaced to the seal face insert (16), and axially extends past the seal face insert (16), the seal face flatness (17) can not be checked after the permanent securing process is complete at circumferential weld (12). This is due to the fact that conventionally, seal face flatness is checked using an optical flat (18). Optical flats (18) are not available with holes in their centre through which the cartridge sleeve (11) may pass.

Furthermore, even if the optical flat (18) was available with a hole in its centre, many optical flats would be required to facilitate a typical mechanical seal size range from 1.000″ to 6.000″ (24 mm to 150 mm) in 0.062″ and 1 mm diametrical increments. This clearly is not commercially practical.

Furthermore, even if a way to check the seal face flatness (17) was found, should it be determined that the seal face flatness (17) was not to tolerance, for example two helium light bands, then it would need to be re-manufactured.

All seal faces are lapped in a random epicyclical motion, on a lapping bed, which itself is very flat. As the cartridge sleeve (11) extends beyond the seal face insert (16), the seal face can not be lapped once permanently secured to cartridge sleeve (11).

The prior art design shown in FIG. 1a is therefore very difficult, if not impossible, to reliably produce, and maintain seal face insert flatness (16) to within 2 light bands, in a production environment. This therefore produces an inconsistent final product, which can cause premature mechanical seal failure.

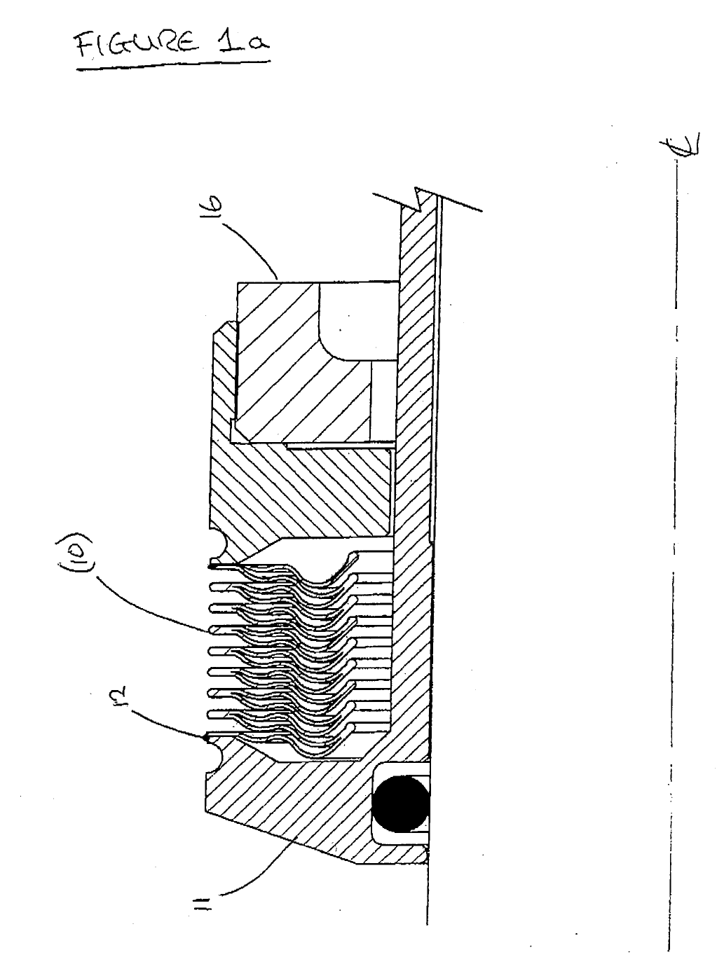

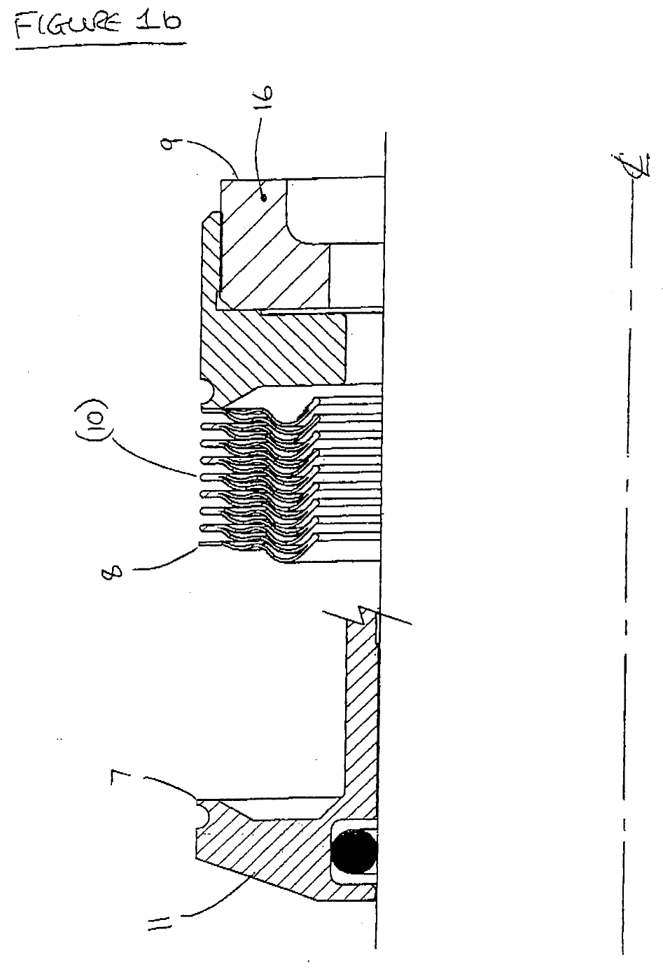

FIG. 2 therefore shows a double rotary bellows mechanical seal according to the invention. The seal is a cartridge seal and comprises a stationary component (21) and a rotary component (22) which defines a seal surface (23) which in turn forms a sliding seal with the stationary component (21).

The rotary component (22) is the floating component, which is urged towards the stationary component by means of at least one spring member (20). From FIG. 2, the spring member shown, by way of example only, is a metal bellows assembly.

The metal bellows assembly (20) is detachable and not permanently secured to cartridge sleeve (25). This is shown by screws (19).

The rotary component (22) is disposed radially outwardly of cartridge sleeve (25), which is a sleeve fixed for rotation with a rotary shaft (26) of an item of mechanical equipment. The deflector (27), is positioned radially outwardly around the sleeve component (25), and in this illustration, is stationary.

FIG. 2, illustrates the barrier fluid (28) entering in the barrier fluid inlet (29) in gland (30), and circulated along the outer radial portion of the deflector (27), and directed towards the inboard sealing faces (23). The barrier fluid (28) is then pulled along the inner radial portion of deflector (27), possibly by an appropriate flow induction device (33) and past the outboard sealing surfaces (31) and towards the Barrier fluid outlet (32) in gland (30). The barrier fluid (28) is then circulated within a closed circuit, preferably, back to the source, then back to the barrier fluid inlet (29).

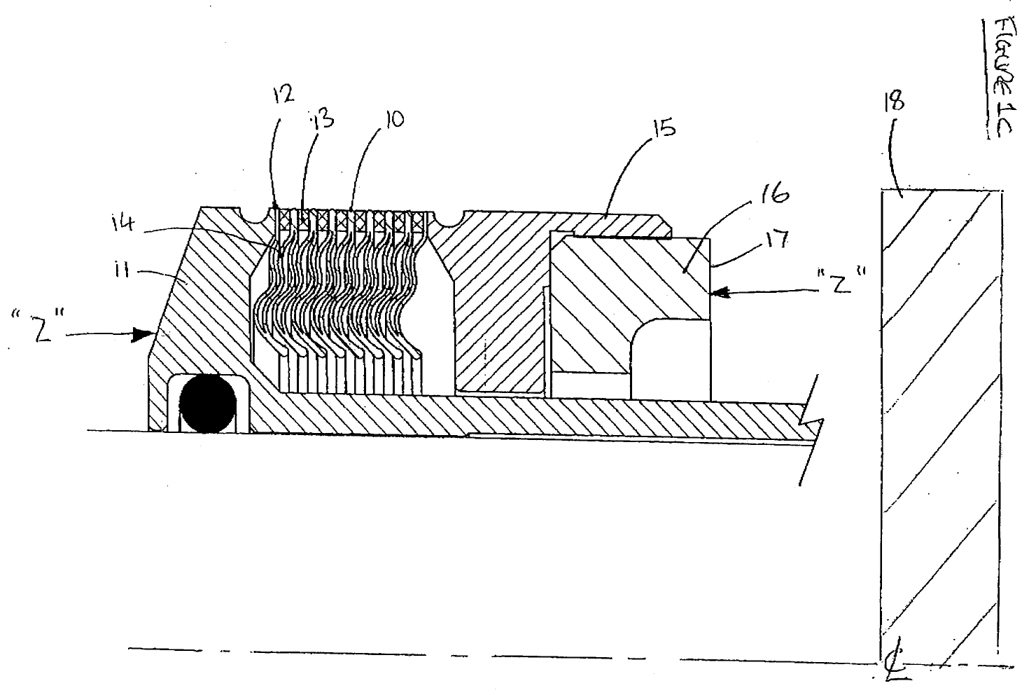

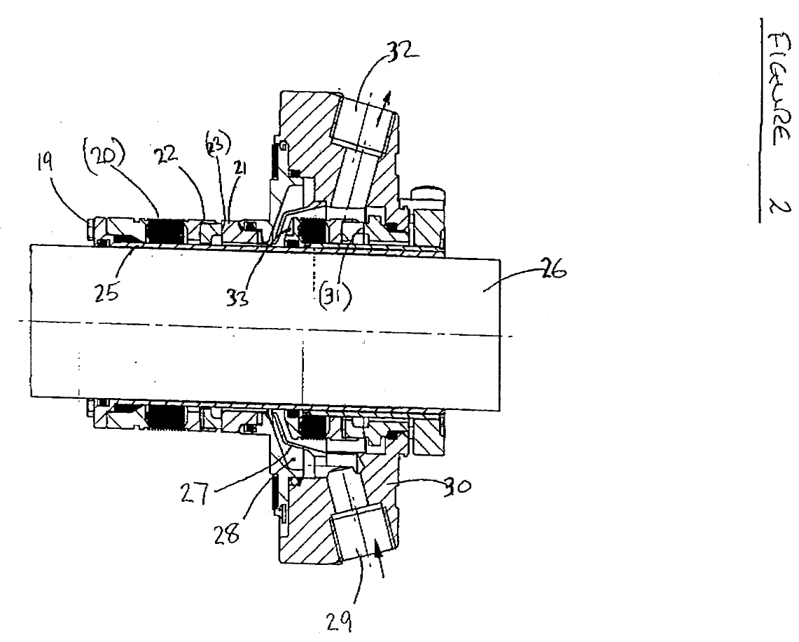

FIG. 2 illustrates the flow induction device (33) is positioned between the inboard sealing faces (23) and outboard sealing faces (31). It is deemed obvious to an experienced reader than said flow induction device (33) could be externally positioned and separate to the mechanical seal assembly. FIG. 3 corresponds to FIG. 2 and is a partial cross section of the invention. From FIG. 3, the external rotating and floating seal face assembly (34) is urged towards the stationary seal face (35) by means of one or more springs (36). The spring member shown in FIG. 3 is at least one metal bellows member.

The sliding interface between the rotating seal face insert (38) and the stationary seal face (35) forms sealing surface (31).

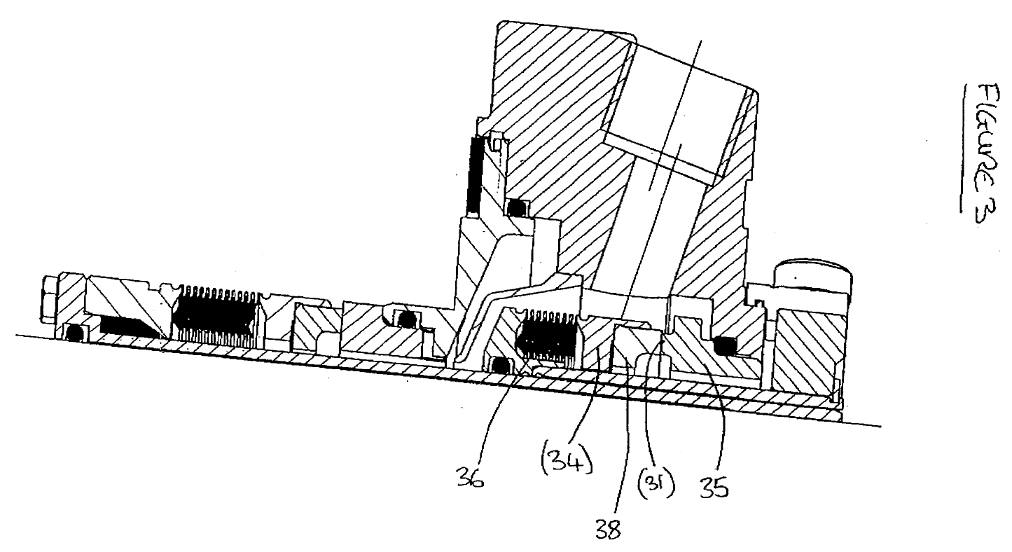

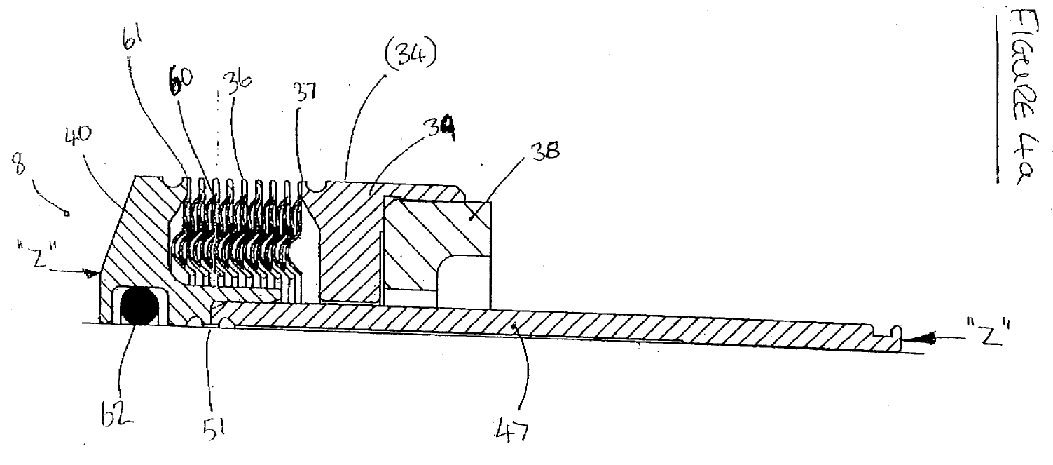

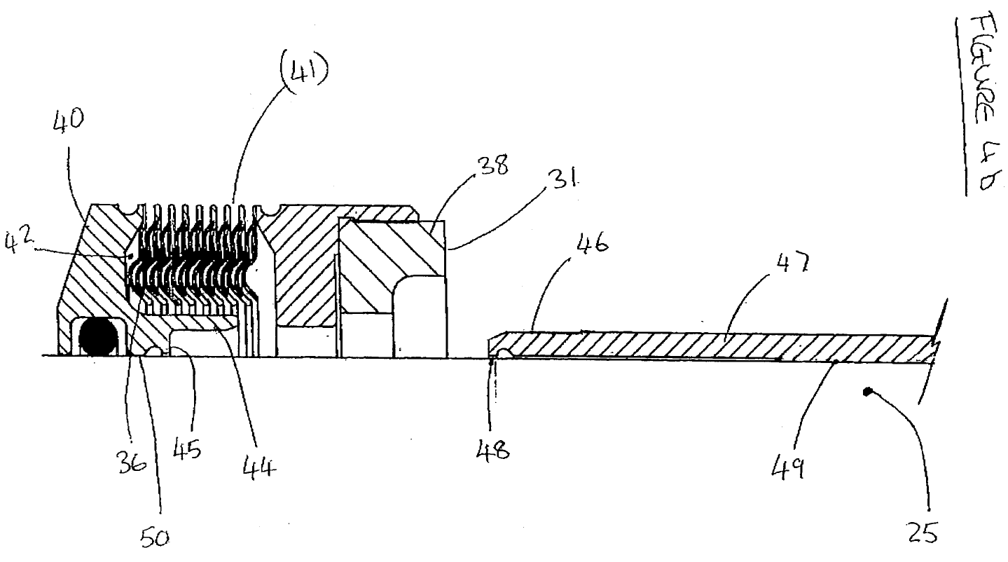

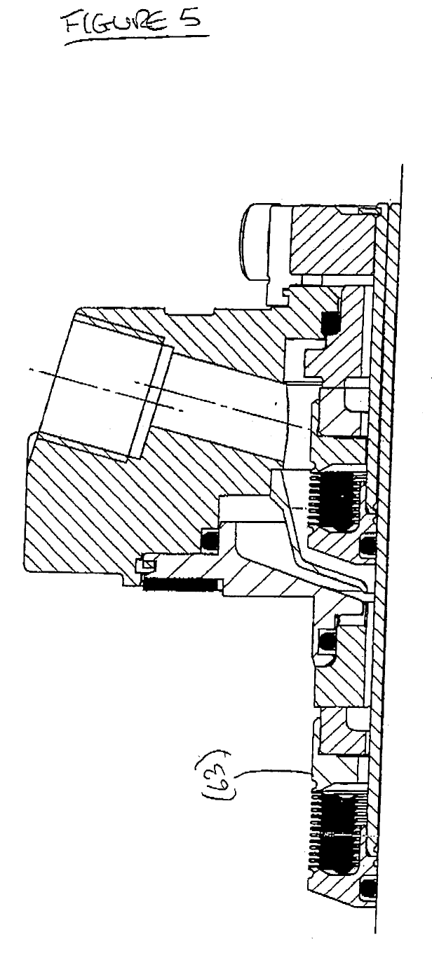

FIG. 4a corresponds to FIG. 3 and shows an enlarged cross section of the external rotary assembly (34) of the invention.

It will be noted that the seal face insert (38) is shrink fitted to the seal face holder (39). The seal face holder (39) is then circumferentially welded (37) on the radially outer portion of the seal face holder (39), to the bellows stack assembly (36). The bellows stack assembly (36) consists of one or more bellows convolutions (60). Said bellows convolution (60) provides the axial spring-type movement, which allows the rotating seal face assembly (34) to maintain axial contact with the stationary seal face (35) forming sealing surface (31).

The opposite side of the bellows stack assembly (37) is circumferentially welded (61) to the radially outer portion of the drive end (40). This creates rotating bellows sub-assembly (41) as shown in FIG. 4b.

An experienced reader will note that the rotating bellows sub-assembly (41) allows the seal face insert (38) to be lapped and face flatness checked.

At one axial side of the drive end (40) is an axial recess (42). Said axial recess (42) allows the bellows stack assembly (36) to fully compress without the radially most inner part of the bellows stack assembly (36) coming into contact with the drive end (40). This prevents unwanted stress loading on the inner most radial part of the bellows stack assembly (36). This, in turn, helps to extend the seal life, and prevent premature mechanical seal failure.

The radially inner part of the drive end (40) has a longitudinal portion (44) and a weld prep portion (45).

The drive end longitudinal portion (44) radially engages into the corresponding longitudinal portion (46) of the drive sleeve (47).

Preferably, however not essentially, said radial engagement of the drive end (40) and drive sleeve (47) is a slight interference or press fit. This helps to ensure that both components are concentrically mounted to each other.

From FIG. 4b it will be noted that said drive sleeve (47) has a weld prep area (48) adjacent to the longitudinal portion (46).

Both weld preps (45) and (48) are preferentially, although not essentially, radially outwardly displaced to drive sleeve location diameter (49) and drive end location diameter (50).

This radial outward displacement helps to ensure that when securing the drive end (40) and drive sleeve (47) together, the resulting fixing, which is preferentially a welded fixing, does not prevent the location diameters (49) and/or (50) from locating on sleeve (25). This weld prep design (45) and (48) of the invention, therefore prevents a subsequent internal machining or grinding operation, which increases the cost of component manufacture.

Referring back to FIG. 4a, before making the final permanent fixing (51) between the drive end (40) and the drive sleeve (47), a very light axial load, denoted as “Z” is given on the end of the drive end (40) and drive sleeve (47). This ensures that both the drive end (40) and drive sleeve (47) are correctly butted to each other at final permanent fixing area (51).

If a gap exists at final permanent fixing area (51), the resulting final permanent fixing may be of poor quality and may lead to premature seal failure. This is therefore undesirable.

An experienced reader will note that from FIG. 4a, the invention offers many technical and commercial advantages over prior art technology.

First and foremost, the seal face insert (38) remains flat after the final permanent securing operation (51) between the drive end (40) and drive sleeve (47). This is due to the fact that no mechanical loading or contact is made to the seal face holder (39) and/or seal face insert (38) after the seal face insert (38) has been lapped and flatness checked.

This ensures the seal face remains flat after the final permanent securing operation (51).

A further advantage of the invention is that the final permanent securing operation between the drive end (40) and drive sleeve (47) is made at the non-pressure side of the bellows rotating seal face assembly (34). This is relevant when the invention is used as a single cartridge mechanical seal, or, as shown in FIG. 2, when the invention is used on the outboard side, or atmospheric side, of a double cartridge mechanical seal.

The final permanent fixing (51) is not effected by the sealed fluid (8) due to the fact that elastomer (62) prevents fluid from contacting the final permanent fixing area (51).

Unlike the prior art technology, this final permanent fixing area (51) does not therefore need to be leak tight. To this extent, the final permanent fixing of the drive end (40) and the drive sleeve (47) could be made using another appropriate means, for example, chemically bonding using an appropriate glue.

A further advantage of the invention is that the final permanent securing operation (51) is axially offset from the bellows stack fixing (61). This means that the design is particularly suited for axially confined spaces, as the drive end can be offered substantially axially thinner than any prior art design. This is a massive benefit on certain types of equipment.

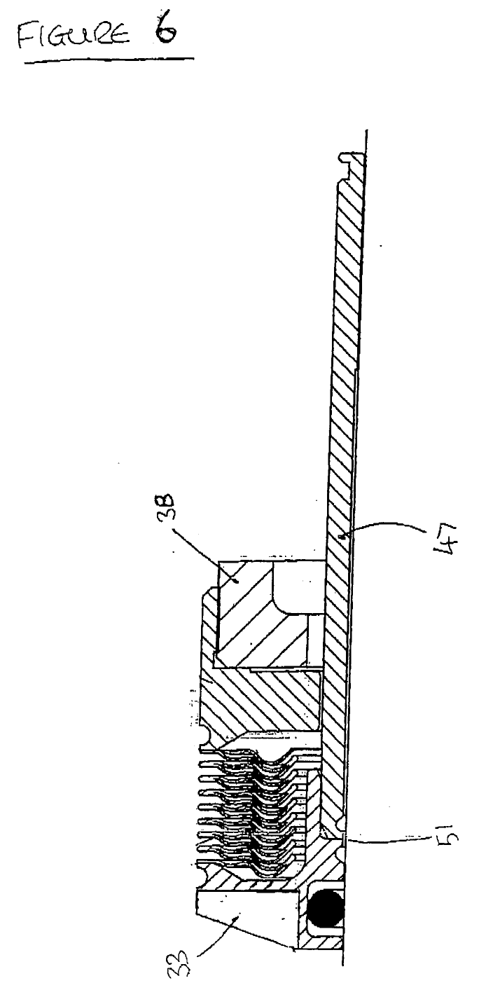

Furthermore, as the final permanent securing operation (51) is axially offset from the bellows stack fixing (61), the space adjacent to the bellows stack fixing (61) can be used, for example, as a flow inducing mechanism (33), which comprises of at least one rotating indentation or slot, as shown in FIG. 6. Again, this is a massive benefit on certain types of equipment that have axial confined spaces.

That which is claimed is:

1. A mechanical seal comprising a drive end, a seal face holder with a seal face inserted into the seal face holder, a metal bellows stack between the drive end and the seal face holder, and a drive sleeve secured to the drive end.

2. A seal as claimed in claim 1 wherein the drive sleeve is a separate component to the drive end.

3. A seal as claimed in claim 1 wherein the drive sleeve is located radially inwardly of the metal bellows stack.

4. A seal as claimed in claim 1 wherein the drive sleeve is secured to the drive end at a securment point, the securment point being located radially inwardly of the metal bellows stack.

5. A seal as claimed in claim 4 wherein the securment point is located axially adjacent to the interface between the bellows stack and the drive end.

6. A seal as claimed in claim 4 wherein the securment point is located axially adjacent to the interface between the bellows stack and the seal face holder.

7. A seal as claimed in claim 1 wherein the seal is configured to minimise and/or substantially eliminate forces or loads, including compressive, tension and/or radial, on the seal face during securment of the drive sleeve to the drive end.

8. A seal as claimed in claim 1 where the drive sleeve is secured to the drive end by at least one of physical means, mechanical means, and chemical means.

9. A seal as claimed in claim 1 wherein the metal bellows stack comprises one or more pairs of metal bellows convolutions.

10. A seal as claimed in claim 1 wherein the metal bellows stack is circumferentially attached to the drive end.

11. A seal as claimed in claim 1 wherein the drive sleeve extends axially past the said seal face.

12. A seal as claimed in claim 1 wherein said drive end comprises a recess, said drive sleeve comprises a protrusion, said protrusion being engagable in said recess.

13. A seal as claimed in claim 12 wherein the recess and/or the protrusion is radially disposed and/or axially extending.

14. A seal as claimed in claim 13 wherein said recess and said protrustion form a radial interference location fit, thereby concentrically mounting one component to the other.

15. A seal as claimed in claim 1 wherein said drive sleeve comprises a recess, said drive end comprises a protrusion, said protrusion being engagable in said recess.

16. A seal as claimed in claim 15 wherein the recess and/or the protrusion is radially disposed and/or axially extending.

17. A seal as claimed in claim 15 wherein said recess and said protrusion form a radial interference location fit, thereby concentrically mounting one component to the other.

18. A seal as claimed in claim 1 wherein said drive end is of the same material as the drive sleeve.

19. A seal as claimed in claim 1 wherein said drive end is of a different material as the drive sleeve.

20. A seal as claimed in claim 1 wherein a point of securement of said drive end to said drive sleeve, is not in contact with a sealed fluid.

21. A seal as claimed in claim 1 wherein said drive end comprises at least one indentation or protrusion.

22. A seal as claimed in claim 1 wherein said drive end comprises an axial recess adjacent to the metal bellows stack.

23. A seal as claimed in claim 1 wherein at least one of said drive end and a drive sleeve weld prep area is radially disposed to radial locations on said drive end and said drive sleeve weld prep area, respectively.

24. A method of assembling a seal, comprising:
locating a metal bellows stack between a drive end and a seal face holder;
inserting a seal face into the seal face holder; and
securing a drive sleeve to the drive end.

25. A method as claimed in claim 24 further comprising:
checking seal face flatness before securing the drive sleeve to the drive end.

26. A method as claimed in 24 further comprising:
axially compressing the metal bellows stack.
